(19) United States
(12) Patent Application Publication
(10) Pub. No.: US 2011/0158643 A1
(43) Pub. Date: Jun. 30, 2011

(54) Optical transmission module and wavelength control method of optical transmission module

(75) Inventor: Toru Yamazaki, Kawasaki (JP)

(73) Assignee: FUJITSU OPTICAL COMPONENTS LIMITED, Kawasaki (JP)

(21) Appl. No.: 12/926,866

(22) Filed: Dec. 14, 2010

(30) Foreign Application Priority Data
Dec. 28, 2009 (JP) 2009-296739

(51) Int. Cl. H04B 10/08

(52) U.S. Cl. 398/38

(57) ABSTRACT

An optical transmission module includes a variable wavelength light source; an alternating current adding unit that adds an alternating current to a drive current to the variable wavelength light source; a first detector to detect optical power of an output light; a filter to input the output light from the variable wavelength light source in which transmission wavelength periodically increases and decreases; a second detector to detect optical power of transmitted light transmitted through the filter; an extraction unit to extract a wavelength fluctuation component of the output light based on the optical power of the output light and the optical power of the transmitted light; a phase comparison unit to compare a phase of the wavelength fluctuation component with a phase of the alternating current; and a wavelength controller to control a wavelength of the output light by controlling a temperature of the variable wavelength light source.

### CROSS-REFERENCE TO RELATED APPLICATIONS

This application is based upon and claims the benefit of priority of the prior Japanese Patent Application No. 2009-296739, filed on Dec. 28, 2009, the entire contents of which are incorporated herein by reference.

### FIELD

The embodiment discussed herein is related to an optical transmission module and a wavelength control method of the optical transmission module.

### BACKGROUND

Japanese Laid-Open Patent Application No. 2009-70852 discloses a control method of an optical transmitter in which the wavelength of output light can be adjusted as desired regardless of the temperature of a laser diode at start. To that end, an opening element adjusts the temperature of a laser diode within a first temperature range and adjusts the temperature of an etalon filter within a second temperature range by controlling a first TEC control element and a second TEC control element. After the temperature of the laser diode is settled within the first temperature range and the temperature of the etalon filter is settled within the second temperature range, the opening element controls the bias circuit to supply the laser diode with a bias current.

### SUMMARY

According to an aspect of the present invention, an optical transmission module includes a variable wavelength light source; an alternating current adding unit to add an alternating current to a drive current to the variable wavelength light source; a first detector to detect optical power of an output light from the variable wavelength light source; a filter to input the output light from the variable wavelength light source in which transmission wavelength periodically increases and decreases and; a second detector to detect optical power of transmitted light transmitted through the filter; an extraction unit to extract a wavelength fluctuation component of the output light from the variable wavelength light source based on the optical power of the output light detected by the first detector and the optical power of the transmitted light detected by the second detector; a phase comparison unit to compare a phase of the wavelength fluctuation component extracted by the extraction unit with a phase of the alternating current added to the drive current by the alternating current adding unit; and a wavelength controller to control a wavelength of the output light from the variable wavelength light source to be a predetermined wavelength by controlling a temperature of the variable wavelength light source in response to the wavelength fluctuation component extracted by the extraction unit and a comparison result of the phase comparison unit.

The object and advantages of the disclosure will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a drawing illustrating an exemplary configuration of a WDM optical transmission system;

FIG. 2 is a drawing illustrating an exemplary configuration of an optical transmission module;

FIG. 3 is a drawing illustrating an exemplary configuration of a laser diode (LD) section;

FIG. 4 is a drawing illustrating a conventional wavelength displacement detection range;

FIG. 5 is a drawing illustrating an exemplary configuration of an optical transmission module according to an embodiment of the present invention;

FIG. 6 is a drawing illustrating phase relationships between a subtraction circuit output and a wavelength fluctuation component;

FIG. 7 is a drawing illustrating a wavelength displacement detection range according to an embodiment of the present invention;

FIG. 8 is a drawing illustrating a discrete representation of a TEC driver output current;

FIG. 9 is another drawing illustrating the discrete change of the TEC driver output current;

FIG. 10 is a drawing illustrating detection of a wavelength displacement amount;

FIG. 11 is a flowchart illustrating a process in switching from ATC (Automatic Temperature Control) to AFC (Automatic Frequency Control) according to an embodiment of the present invention;

FIG. 12 is a flowchart illustrating a process of detecting the wavelength displacement according to an embodiment of the present invention;

FIG. 13 is a flowchart illustrating an alarm process according to an embodiment of the present invention; and

FIG. 14 is a flowchart illustrating a monitor output process according to an embodiment of the present invention.

### DESCRIPTION OF EMBODIMENT

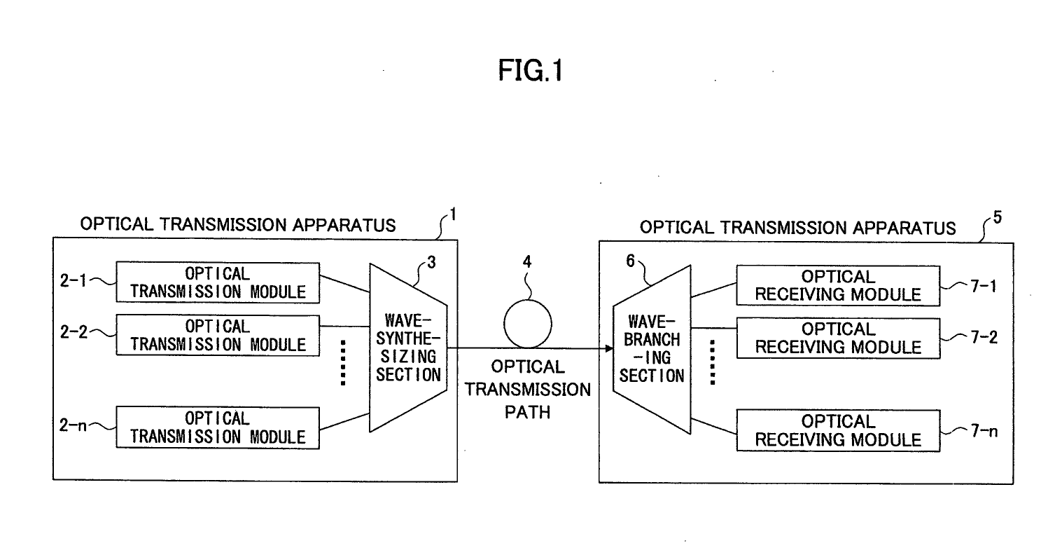

FIG. 1 illustrates an exemplary configuration of a WDM (Wavelength Division Multiplexer) optical transmission system. As illustrated in FIG. 1, an optical transmission system 1 includes plural optical transmission modules 2-1 through 2-n and a wave-synthesizing section 3. Each of the optical transmission modules 2-1 through 2-n converts an electric signal into an optical signal and outputs the converted optical signal. Further, the optical transmission modules 2-1 through 2-n output the optical signals having different wavelengths from each other. Those optical signals are waveform-multiplexed by the wave-synthesizing section 3, and the waveform-multiplexed signal is transmitted as a WDM signal to an optical transmission path 4.

The WDM signal transmitted through the optical transmission path 4 is supplied to an optical transmission apparatus 5. As illustrated in FIG. 1, the optical transmission apparatus 5 includes a wave-branching section 6 and plural optical receiving modules 7-1 through 7-n. The wave-branching section 6 separates the received WDM signal into plural optical signals having different wavelengths from each other, and supplies the optical signals to the optical receiving modules 7-1 through 7-n. Each of the optical receiving modules 7-1 through 7-n converts an optical signal into an electric signal.

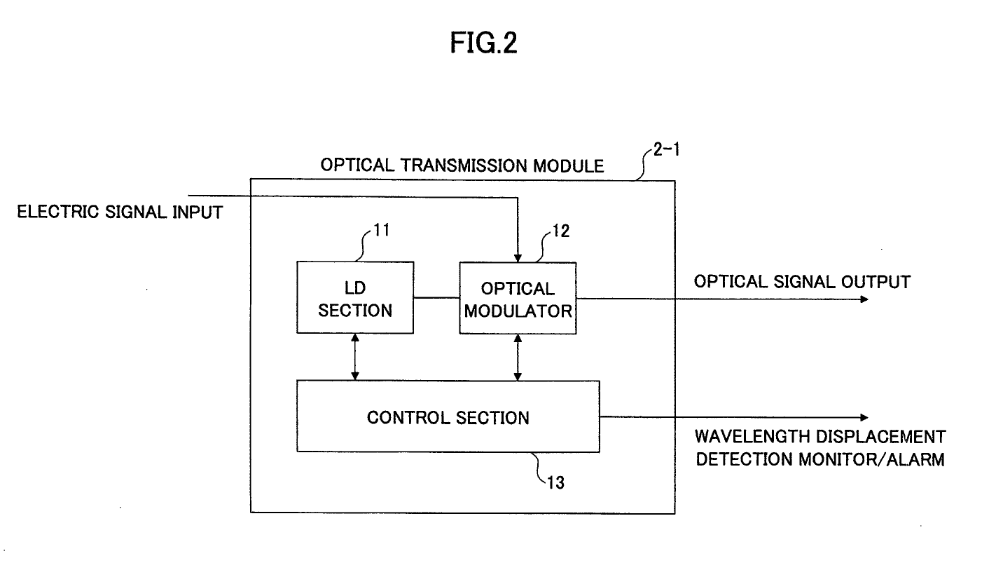

FIG. 2 illustrates an exemplary configuration of the optical transmission module. As illustrated in FIG. 2, the optical transmission module 2-1 includes a laser diode (LD) section 11, an optical modulator 12, and a control section 13. The LD section 11 generates an optical signal having a predetermined wavelength in response to control from the control section 13, and supplies the generated optical signal to the optical modulator 12. The optical modulator 12 modulates the optical signal supplied from the LD section 11 based on an externally supplied electric signal in response to control from the control section 13, and supplies the modulated optical signal to the wave-synthesizing section 3. The control section 13 receives a detection signal of the optical signal output from the LD section 11, and outputs a wavelength displacement detection monitor value or an alarm.

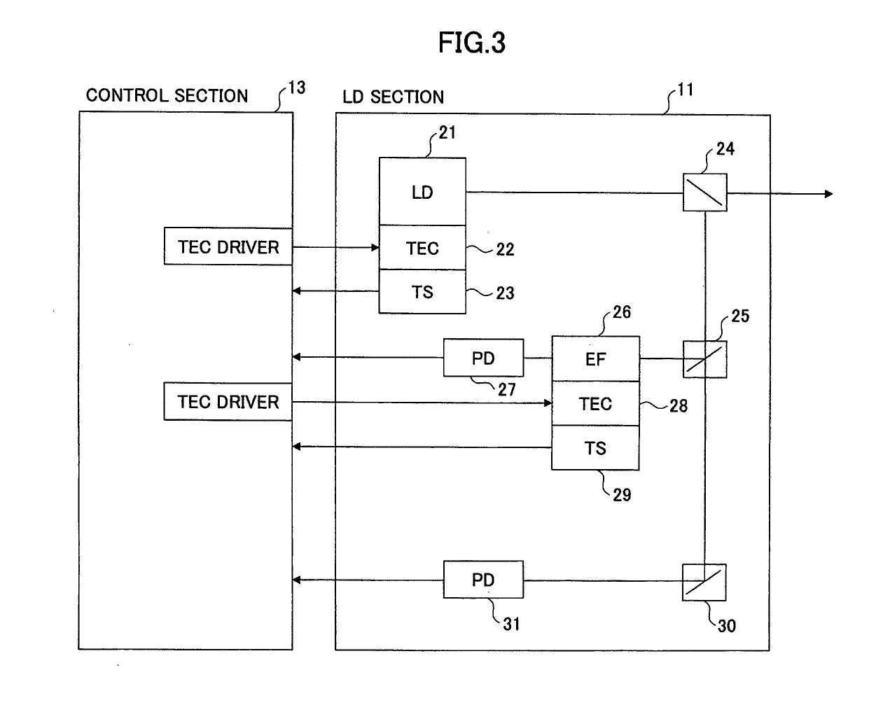

FIG. 3 illustrates an exemplary configuration of the LD section 11 in a conventional optical transmission module. As illustrated in FIG. 3, a laser diode (LD) 21 as a variable wavelength light source in the LD section 11 is equipped with a thermo electric controller (TEC) 22 such as a Peltier device. The setting temperature of the thermo electric controller (TEC) 22 varies under control of the control section 13. Depending on the setting temperature of the thermo electric controller (TEC) 22, the wavelength of the optical light output from the laser diode (LD) 21 varies. A temperature sensor (TS) 23 detects the temperature of the thermo electric controller (TEC) 22, and supplies the detected temperature to the control section 13.

A part of the optical signal output from the laser diode (LD) 21 is separated by an optical branching section 24. A part of the separated optical signal is further separated by another optical branching section 25, and is supplied to an etalon filter (EF) 26. The optical signal output from the etalon filter (EF) 26 is supplied to a photo diode (PD) 27. The output signal from the photo diode (PD) 27 is supplied as a detection signal to the control section 13. The etalon filter (EF) 26 is equipped with a thermo electric controller (TEC) 28. The temperature of the thermo electric controller (TEC) 28 is kept constant under the control of the controller 13. A temperature sensor (TS) 29 detects the temperature of the thermo electric controller (TEC) 28, and supplies the detected temperature to the control section 13. Further, the other part of the optical signal separated by the optical branching section 25 is supplied to a photo diode (PD) 31 via an optical reflector 30.

The detection signal output from the photo diode (PD) 31 is supplied to the control section 13. The control section 13 performs wavelength stabilization control (i.e., automatic frequency control (AFC)) by changing the setting temperature of the thermo electric controller (TEC) 22 so that the wavelength of the optical signal output from the laser diode (LD) 21 is settled at the wavelength lock point by using the transmission characteristics of the etalon filter (EF) 26, the characteristics having a constant periodicity of the wavelength.

Further, conventionally, there is a known technique of controlling an optical transmission apparatus capable of adjusting the wavelength of the output light to a desired wavelength regardless of the temperature of the laser diode (LD) at start by using the etalon filter (EF) (see for example, Japanese Laid-Open Patent Application No. 2009-70852).

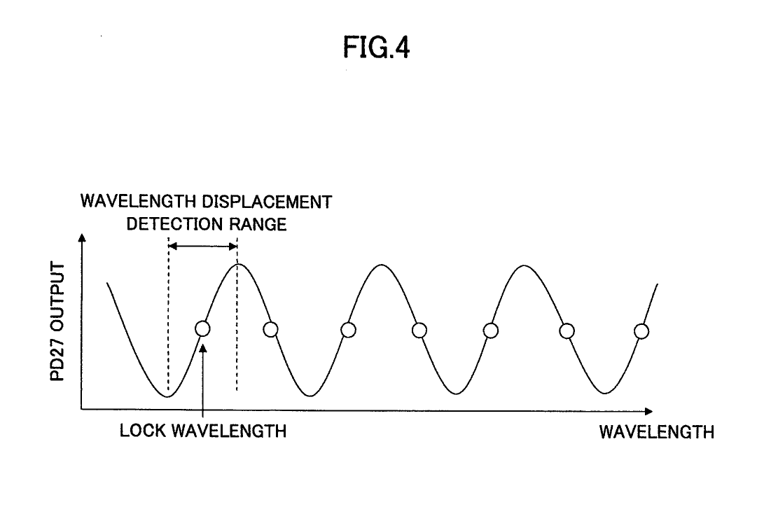

In a conventional optical transmission module as illustrated in FIG. 3, in order to control the oscillation wavelength of the laser diode (LD) 21 to be at the lock wavelength, it is a general practice to control the temperature of the laser diode (LD) 21 to be a target value (i.e., perform automatic temperature control (ATC)) first, and finally control the oscillation wavelength of the laser diode (LD) to be at the lock wavelength by using the transmission characteristics of the etalon filter (EF) 26 for the wavelength as illustrated in FIG. 4 (perform automatic frequency control (AFC)).

However, as described above, the transmission characteristics of the etalon filter (EF) 26 for the wavelength has a periodicity. Therefore, upon the wavelength control, the wavelength control range corresponding to the wavelength lock point which is indicated as a white circle in FIG. 4 (i.e., wavelength displacement detection range) may be limited to a half cycle of the periodicity of the etalon filter (EF) 26. Namely, there is a problem that the wavelength control range (i.e., wavelength displacement detection range) is narrow.

The present invention is made in light of the problem, and may provide an optical transmission module having an expanded (wider) wavelength control range.

In the following, an embodiment of the present invention is described with reference to the accompanying drawings.

### Configuration of Optical Transmission Module

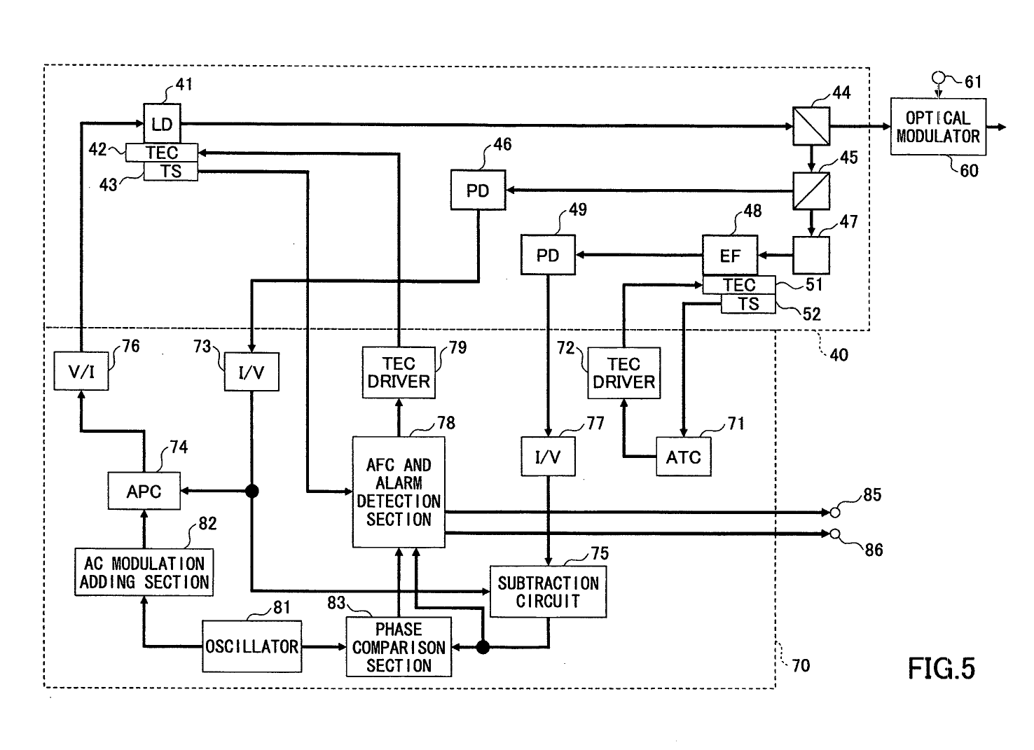

FIG. 5 illustrates an exemplary configuration of an optical transmission module according to an embodiment of the present invention. As illustrated in FIG. 5, the optical transmission module includes a laser diode (LD) section 40, an optical modulator 60, and a control section 70.

The laser diode (LD) section 40 includes a laser diode (LD) 41. The laser diode (LD) 41 receives a drive current from the control section 70, and emits light based on the drive current. Further, the laser diode (LD) 41 is equipped with a thermo electric controller (TEC) 42 such as the Peltier device. The setting temperature of the thermo electric controller (TEC) 42 varies under control of the control section 70. Depending on the setting temperature of the thermo electric controller (TEC) 42, the wavelength of the optical signal output from the laser diode (LD) 41 varies. A temperature sensor (TS) 43 detects the temperature of the thermo electric controller (TEC) 42, and supplies the detected temperature to the control section 70.

The optical signal output from the laser diode (LD) 41 is supplied to the optical modulator 60 via an optical branching section 44. The optical modulator 60 modulates the optical signal from the laser diode (LD) 41 based on the electric signal received via a terminal 61, and outputs the modulated optical signal. Further, a part of the optical signal output from the laser diode (LD) 41 is separated by the optical branching section 44. The separated optical signal is further separated into two optical signals by another optical branching section 45. One of the two optical signals is supplied to a photo diode (PD) 46. The photo diode (PD) 46 detects the power of the optical signal, generates a power detection signal in a form of a current signal and supplies the generated power detection signal to the control section 70.

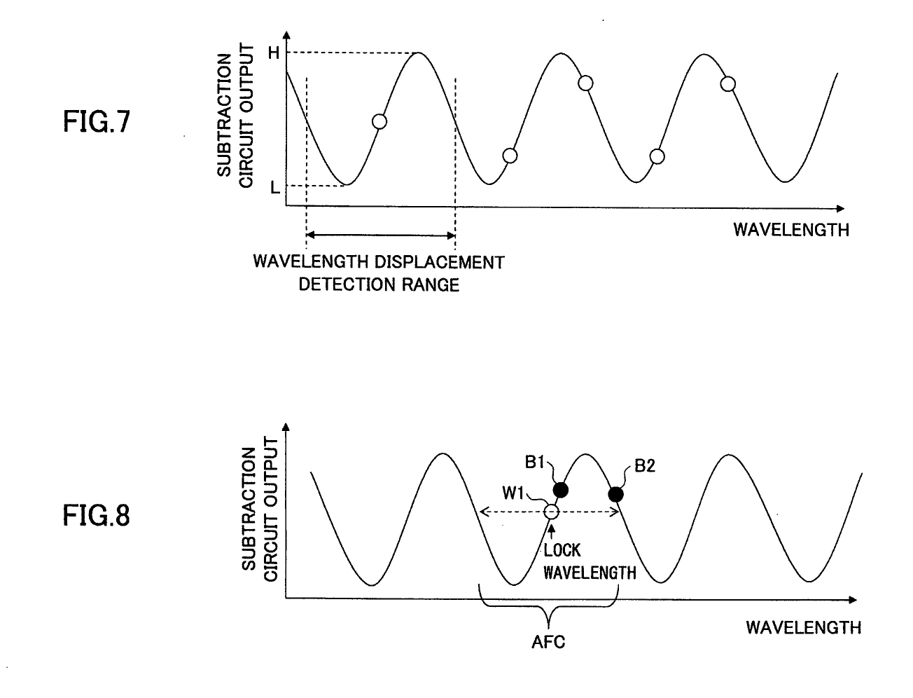

On the other hand, the other of the two optical signals is supplied to an etalon filter (EF) 48 via an optical reflector 47. The etalon filter (EF) 48 has light transmission characteristics as illustrated in a solid line of FIG. 4 (or FIG. 7) in which the light transmission rate increases and decreases at a constant period of wavelength (i.e., characteristics in which the transmission wavelength periodically increases and decreases). The transmitted light transmitted through the etalon filter (EF) 48 is supplied to a photo diode (PD) 49. The transmitted light power detection signal output from the photo diode (PD) 49 is supplied to the control section 70. The etalon filter (EF) 48 is equipped with a thermo electric controller (TEC) 51 such as the Peltier device. A temperature sensor 52 detects the temperature of the thermo electric controller (TEC) 51, and supplies the detected temperature (temperature detection signal) to the control section 70.

In the control section 70, in response to the receipt of the temperature detection signal, an automatic temperature control (ATC) section 71 generates a control signal to set the temperature of the thermo electric controller (TEC) 51 to a determined temperature. A TEC driver (TEC-DRV) 72 generates a drive current in accordance with the control signal supplied from the automatic temperature control (ATC) section 71, and supplies the generated drive current to the thermo electric controller (TEC) 51. By doing this, the temperature of the thermo electric controller (TEC) 51 may be variably adjusted.

A current/voltage convertor (I/V) 73 converts the power detection signal in a form of a current signal output from the photo diode (PD) 46 into a signal in a form of a voltage signal. Further, the current/voltage convertor (I/V) 73 supplies the converted signal to an automatic power control (APC) section 74 and a subtraction circuit 75. The automatic power control (APC) section 74 generates a drive signal in a form of a voltage signal to control the optical signal power output from the photo diode (PD) 46 to be constant. Further, an oscillation component (alternating current (AC) component) having a predetermined frequency output from an oscillator 81 is also supplied to the automatic power control (APC) section 74 via an AC modulation adding section 82, so that the automatic power control (APC) section 74 performs alternating-current modulation (AC modulation) in which the oscillation signal is added to the drive signal. The AC-modulated control signal is converted into a signal in a form of a current signal in a voltage/current converter (V/I) 76, and the converted signal is supplied to the laser diode (LD) 41.

A current/voltage convertor (I/V) 77 converts the transmitted light power detection signal in the form of a current signal output from the photo diode (PD) 49 into a signal in a form of a voltage signal, and supplies the converted signal to the subtraction circuit 75.

An automatic frequency control (AFC) and alarm detection section 78 receives the temperature detection signal supplied from the temperature sensor (TS) 43. The automatic frequency control (AFC) and alarm detection section 78 generates an ATC control signal to control the temperature of the thermo electric controller (TEC) 42 to be constant in response to the temperature detection signal, and supplies the generated ATC control signal to the thermo electric controller (TEC) 42. Along with this, the automatic frequency control (AFC) and alarm detection section 78 generates an AFC control signal to adjust the wavelength of the optical signal output from the laser diode (LD) 41 to be constant in response to the DC voltage output from the subtraction circuit 75 and phase comparison information from a phase comparison section 83, and supplies the generated AFC control signal to the thermo electric controller (TEC) 42.

Further, the automatic frequency control (AFC) and alarm detection section 78 outputs a wavelength displacement amount as monitor output via a terminal 85. Further, the automatic frequency control (AFC) and alarm detection section 78 generates an alarm upon the wavelength displacement amount being beyond a predetermined alarm determination range and outputs the alarm via a terminal 86.

The ATC control signal or the AFC control signal is supplied to a TEC driver (TEC-DRV) 79. The TEC driver (TEC-DRV) 79 generates a drive current in accordance with the ATC control signal or the AFC control signal, and supplies the generated control signal to the thermo electric controller (TEC) 42. By doing this, the temperature of the thermo electric controller (TEC) 42 may be variably adjusted, thereby variably adjusting the wavelength of the optical signal output from the laser diode (LD) 41.

The subtraction circuit 75 subtracts the power detection signal of the current/voltage convertor (I/V) 73 from the transmitted light power detection signal of the current/voltage convertor (I/V) 77, and supplies the subtraction result to the phase comparison section 83 and the automatic frequency control (AFC) and alarm detection section 78. The phase comparison section 83 compares the phase of the oscillation signal having the predetermined frequency output from the oscillator 81 and the phase of the output signal from the subtraction circuit 75. Namely, the phase comparison section 83 determines whether the phase of the output signal from the subtraction circuit 75 is the same as the phase of the oscillation signal (i.e., in-phase) or the phase of the output signal from the subtraction circuit 75 is opposite to the phase of the oscillation signal (i.e., anti-phase). Further, the phase comparison section 83 supplies the determination result (phase comparison information) to the automatic frequency control (AFC) and alarm detection section 78.

Herein, when the laser diode (LD) 41 is driven by using the AC-modulated current, a power fluctuation and a wavelength fluctuation may occur in the output light from the laser diode (LD) 41. In this case, only the power fluctuation is detected in the output of the photo diode (PD) 46. On the other hand, the photo diode (PD) 49 detects the power of the transmitted light transmitted through the etalon filter (EF) 48 (i.e., photo diode (PD) 49 detects the power of the optical signal including the power fluctuation that has been converted from the wavelength fluctuation of the output light from the laser diode (LD) 41 by the etalon filter (EF) 48). Therefore, the output from the photo diode (PD) 49 includes the fluctuation components of both the power fluctuation and the wavelength fluctuation. Because of this feature, it may become possible to extract only the wavelength fluctuation component by subtracting the output value of the current/voltage convertor (I/V) 73 from the output value of the current/voltage convertor (I/V) 77 by the subtraction circuit 75.

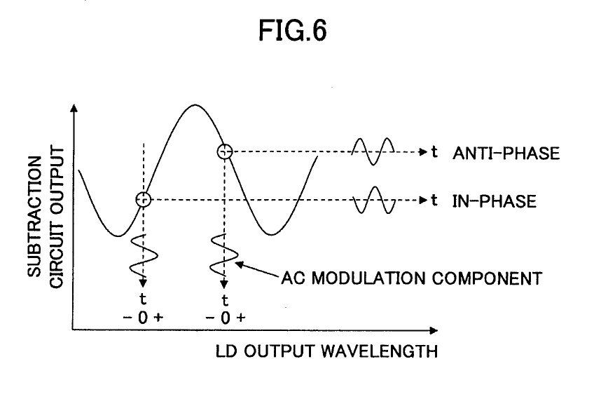

FIG. 6 illustrates phase relationships between the output of the subtraction circuit 75 and the output wavelength of the laser diode (LD) 41. As illustrated in FIG. 6, when the output wavelength of the laser diode (LD) 41 is disposed within an upward-sloping section (where the output of the subtraction circuit 75 increases as the increase of the output wavelength of the laser diode (LD) 41) (e.g., at the left white circle in FIG. 6) of the output of the subtraction circuit 75, the wavelength fluctuation component of the output of the subtraction circuit 75 is in phase with the output of the oscillator 81. On the other hand, when the output wavelength of the laser diode (LD) 41 is disposed within a downward-sloping section (where the output of the subtraction circuit 75 decreases as the increase of the output wavelength of the laser diode (LD) 41) (e.g., at the right white circle in FIG. 6) of the output of the subtraction circuit 75, the wavelength fluctuation component of the output of the subtraction circuit 75 is anti-phase (inverted) with the output of the oscillator 81.

Namely, by performing the wavelength control and the calculation of the wavelength displacement detection by the automatic frequency control (AFC) and alarm detection section 78 by using the determination result of the phase comparison section 83, it may become possible to expand the wavelength control range (i.e., the wavelength displacement detection range) from the wavelength lock point due to the periodicity of the etalon filter (EF) 48 to one cycle of the periodicity of the etalon filter (EF) 48 (i.e., almost twice the conventional wavelength control range) as illustrated in FIG. 7.

On the other hand, in a case where the automatic frequency control (AFC) is performed within the wavelength control range, when the wavelength control range from the wavelength lock point is expanded, if the emission wavelength of the laser diode (LD) 41 indicated as the black circle B1 in FIG. 8 is disposed close to the lock wavelength indicated in the while circle W1 (in this case, both the black circle B1 and the white circle W1 are disposed within the upward-sloping section), the settling time to the lock wavelength may be short. On the other hand, if the emission wavelength of the laser diode (LD) 41 indicated as the black circle B2 is disposed relatively far from the lock wavelength (in this case, the black circle B2 is disposed within the downward-sloping section), the settling time to the lock wavelength may become longer.

In terms of the settling time, however, it may become possible to reduce the settling time (control settling time) by discretely (intermittently) changing the output current of the TEC driver (TEC-DRV) 79 upon switching from the automatic temperature control (ATC) to the automatic frequency control (AFC). For example, when assuming that the maximum value of the output current of the TEC driver (TEC-DRV) 79 is several hundreds mA, the discrete change (step) of the output current may be set to a value in a range from several mA to several tens mA.

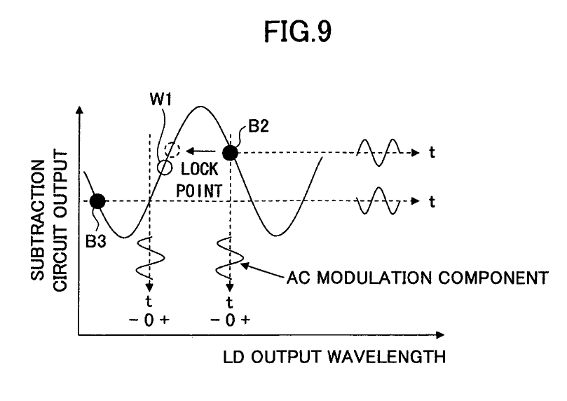

Next, a case is described where the lock wavelength is disposed within an upward-sloping section of the etalon filter (EF) 48 and the phase of the AC modulation component of the subtraction circuit 75 is opposite to the phase of the output of the oscillator 81, and the output DC (direct current) voltage of the subtraction circuit 75 is greater than the voltage of the lock wavelength, that is, the output DC voltage of the subtraction circuit 75 is disposed on the longer wavelength side of the voltage of the lock wavelength. For example, the black circle B2 in FIG. 9 illustrates this case. In FIG. 9, the white circle W1 indicates the wavelength lock point. In this case, the automatic frequency control (AFC) and alarm detection section 78 discretely changes the drive current of the TEC driver (TEC-DRV) 79 in a manner such that the output light of the laser diode (LD) 41 is shifted towards the shorter wavelength side, and when the phase of the AC modulation component of the subtraction circuit 75 is the same as the phase of the output of the oscillator 81, a normal automatic frequency control (AFC) is started that the drive current of the TEC driver (TEC-DRV) 79 is continuously changed.

Next, a case is described where the phase of the AC modulation component of the subtraction circuit 75 is opposite to the phase of the output of the oscillator 81 and the output DC (direct current) voltage of the subtraction circuit 75 is lower than the voltage of the lock wavelength, that is, the output DC voltage of the subtraction circuit 75 is disposed on the shorter wavelength side of the voltage of the lock wavelength. For example, the black circle B3 in FIG. 9 illustrates this case. In this case, the automatic frequency control (AFC) and alarm detection section 78 discretely changes the drive current of the TEC driver (TEC-DRV) 79 in a manner such that the output light of the laser diode (LD) 41 is shifted towards the longer wavelength side, and when the phase of the AC modulation component of the subtraction circuit 75 is the same as the phase of the output of the oscillator 81, the normal automatic frequency control (AFC) is started that the drive current of the TEC driver (TEC-DRV) 79 is continuously changed.

On the other hand, a case is described where the lock wavelength is disposed within an downward-sloping section of the etalon filter (EF) 48 and the phase of the AC modulation component of the subtraction circuit 75 is the same as the phase of the output of the oscillator 81, and the output DC (direct current) voltage of the subtraction circuit 75 is greater than the voltage of the lock wavelength, that is, the output DC voltage of the subtraction circuit 75 is disposed on the shorter wavelength side of the voltage of the lock wavelength. In this case, the automatic frequency control (AFC) and alarm detection section 78 discretely changes the drive current of the TEC driver (TEC-DRV) 79 in a manner such that the output light of the laser diode (LD) 41 is shifted towards the longer wavelength side, and when the phase of the AC modulation component of the subtraction circuit 75 is opposite to the phase of the output of the oscillator 81, the normal automatic frequency control (AFC) is started that the drive current of the TEC driver (TEC-DRV) 79 is continuously changed.

Next, a case is described where the phase of the AC modulation component of the subtraction circuit 75 is the same as the phase of the output of the oscillator 81 and the output DC (direct current) voltage of the subtraction circuit 75 is lower than the voltage of the lock wavelength, that is, the output DC voltage of the subtraction circuit 75 is disposed on the longer wavelength side of the voltage of the lock wavelength. In this case, the automatic frequency control (AFC) and alarm detection section 78 discretely changes the drive current of the TEC driver (TEC-DRV) 79 in a manner such that the output light of the laser diode (LD) 41 is shifted towards the shorter wavelength side, and when the phase of the AC modulation component of the subtraction circuit 75 is opposite to the phase of the output of the oscillator 81, the normal automatic frequency control (AFC) is started that the drive current of the TEC driver (TEC-DRV) 79 is continuously changed.

### Detection of Wavelength Displacement Amount

The automatic frequency control (AFC) and alarm detection section 78 detects the wavelength displacement amount based on the output DC voltage of the subtraction circuit 75 and the phase comparison information from the phase comparison section 83.

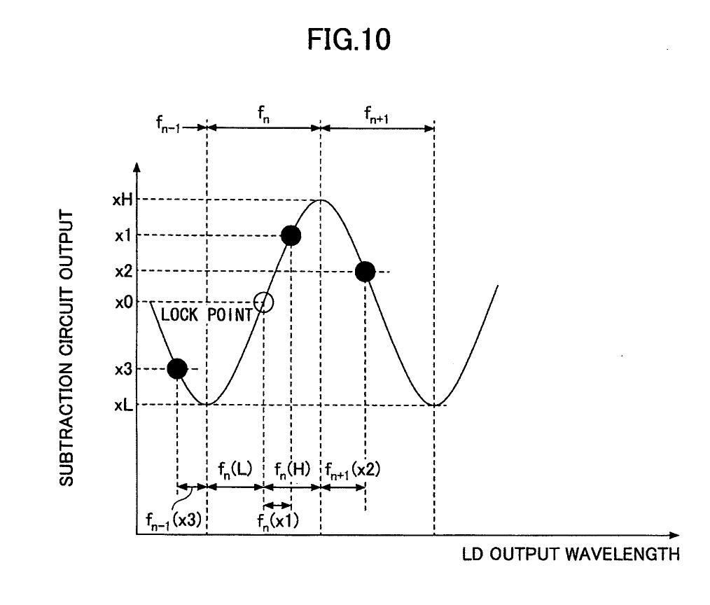

Herein, with reference to FIG. 10, a case is described where the lock wavelength (wavelength lock point) is disposed within the upward-sloping section (fₙ) of the etalon filter (EF) 48. When the phase of the AC modulation component of the subtraction circuit 75 is the same as the phase of the output of the oscillator 81 and the output DC voltage (x1) of the subtraction circuit 75 is greater than the voltage (x0) of the lock wavelength, the wavelength displacement amount D1 is given in the following formula:

D1=fₙ(x1)

wherein the value of fₙ(x1) is obtained based on the inclination of the upward-sloping section (fₙ) of the etalon filter (EF) 48 and the voltage values x1 and x0.

Further, when the phase of the AC modulation component of the subtraction circuit 75 is opposite to the phase of the output of the oscillator 81 and the output DC voltage (x2) of the subtraction circuit 75 is greater than the voltage (x0) of the lock wavelength, the wavelength displacement amount D2 is given in the following formula:

D2=fₙ₊₁(x2)+fₙ(H)

wherein the value of fₙ₊₁(x2) is obtained based on the inclination of the downward-sloping section (fₙ₊₁) of the etalon filter (EF) 48, the voltage value x2, and the maximum voltage value xH of the slope. Further, the value of fₙ(H) is obtained based on the inclination of the upward-sloping section (fₙ) of the etalon filter (EF) 48 and the voltage values x0 and xH.

Further, when the phase of the AC modulation component of the subtraction circuit 75 is opposite to the phase of the output of the oscillator 81 and the output DC voltage (x3) of the subtraction circuit 75 is lower than the voltage (x0) of the lock wavelength, the wavelength displacement amount D3 is given in the following formula:

D3=fₙ₋₁(x3)+fₙ(L)

wherein the value of fₙ₋₁(x3) is obtained based on the inclination of the downward-sloping section (fₙ₋₁) of the etalon filter (EF) 48, the voltage value x3, and the minimum voltage value xL of the slope. Further, the value of fₙ(L) is obtained based on the inclination of the upward-sloping section (fₙ) of the etalon filter (EF) 48 and the voltage values x0 and xL.

Next, a case is described where the lock wavelength (wavelength lock point) is disposed within the downward-sloping section (fₙ₊₁) of the etalon filter (EF) 48.

When the phase of the AC modulation component of the subtraction circuit 75 is opposite to the phase of the output of the oscillator 81 and the output DC voltage (x4) of the subtraction circuit 75 is greater than the voltage (x0) of the lock wavelength, the wavelength displacement amount D4 is given in the following formula:

D4=fₙ₊₁(x4)

wherein the value of fₙ₊₁(x4) is obtained based on the inclination of the downward-sloping section (fₙ₊₁) of the etalon filter (EF) 48 and voltage values x4 and x0.

Further, when the phase of the AC modulation component of the subtraction circuit 75 is the same as the phase of the output of the oscillator 81 and the output DC voltage (x5) of the subtraction circuit 75 is greater than the voltage (x0) of the lock wavelength, the wavelength displacement amount D5 is given in the following formula:

D5=fₙ(x5)+fₙ₊₁(H)

wherein the value of fₙ(x5) is obtained based on the inclination of the upward-sloping section (fₙ) of the etalon filter (EF) 48, the voltage values x5, and the maximum voltage value xH of the slope. Further, the value of fₙ₊₁(H) is obtained based on the inclination of the downward-sloping section (fₙ₊₁) of the etalon filter (EF) 48 and the voltage values x0 and xH.

Further, when the phase of the AC modulation component of the subtraction circuit 75 is the same as the phase of the output of the oscillator 81 and the output DC voltage (x6) of the subtraction circuit 75 is lower than the voltage (x0) of the lock wavelength, the wavelength displacement amount D6 is given in the following formula:

D6=fₙ₊₂(x6)+fₙ₊₁(L)

wherein the value of fₙ₊₂(x6) is obtained based on the inclination of the downward-sloping section (fₙ₊₂) of the etalon filter (EF) 48, the voltage value x6, and the minimum voltage value xL of the slope. Further, the value of fₙ₊₁(L) is obtained based on the inclination of the downward-sloping section (fₙ₊₁) of the etalon filter (EF) 48 and the voltage values x0 and xL.

Flowchart for Process in Switching from ATC to AFC

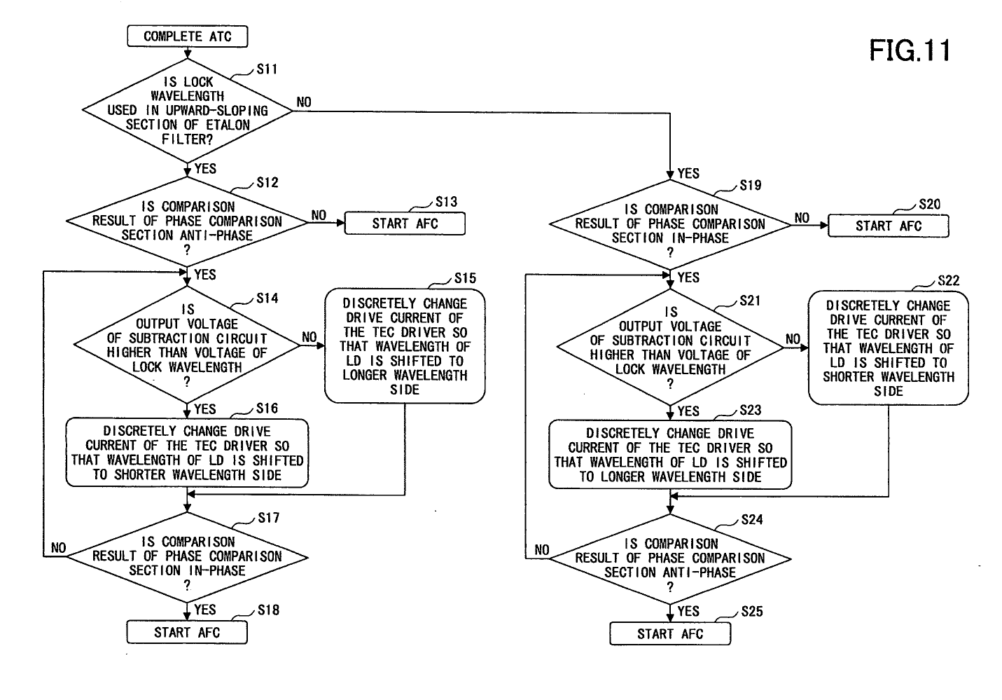

FIG. 11 is a flowchart illustrating a process in switching from the automatic temperature control (ATC) to the automatic frequency control (AFC) performed by the automatic frequency control (AFC) and alarm detection section 78 according to an embodiment of the present invention. This process is executed after the automatic frequency control (AFC) is completed.

As illustrated in FIG. 11, in step S11, it is determined whether the lock wavelength (wavelength lock point) is used in (disposed within) an upward-sloping section of the etalon filter (EF) 48. When determining that the lock wavelength (wavelength lock point) is used in (disposed within) the upward-sloping section (YES in step S11), the process goes to step S12. In step S12, it is further determined whether the result of the comparison executed by the phase comparison section 83 is anti-phase (inverted phase). When determining that the result is in-phase (NO in step S12), the process goes to step S13 to start the automatic frequency control (AFC).

On the other hand, when determining that the result is anti-phase (YES in step S12), the process goes to step S14. In step S14, it is further determined whether the output DC voltage of the subtraction circuit 75 is greater than the voltage of the lock wavelength. When determining that the output DC voltage of the subtraction circuit 75 is equal to or less than the voltage of the lock wavelength (NO in step S14), the process goes to step S15. In step S15, the drive current from the TEC driver (TEC-DRV) 79 is discretely changed so that the output light of the laser diode (LD) 41 is shifted towards the longer wavelength side.

On the other hand, when determining that the output DC voltage of the subtraction circuit 75 is greater than the voltage of the lock wavelength (YES in step S14), the process goes to step S16. In step S16, the drive current from the TEC driver (TEC-DRV) 79 is discretely changed so that the output light of the laser diode (LD) 41 is shifted towards the shorter wavelength side.

After execution of step S15 or step S16, process goes to step S17. In step S17, it is further determined whether the result of the comparison executed by the phase comparison section 83 is in-phase. When determining that the result is anti-phase (NO in step S17), the process goes back to step S14. On the other hand, when determining that the result is in-phase (YES in step S17), the process goes to step S18 to start the automatic frequency control (AFC).

On the other hand, when determining that the lock wavelength (wavelength lock point) is used in (disposed within) a downward-sloping section (NO in step S11), the process goes to step S19. In step S19, it is further determined whether the result of the comparison executed by the phase comparison section 83 is in-phase. When determining that the result is anti-phase (NO in step S19), the process goes to step S20 to start the automatic frequency control (AFC).

On the other hand, when determining that the result is in-phase (YES in step S19), the process goes to step S21. In step S21, it is further determined whether the output DC voltage of the subtraction circuit 75 is greater than the voltage of the lock wavelength. When determining that the output DC voltage of the subtraction circuit 75 is equal to or less than the voltage of the lock wavelength (NO in step S21), the process goes to step S22. In step S22, the drive current from the TEC driver (TEC-DRV) 79 is discretely changed so that the output light of the laser diode (LD) 41 is shifted towards the shorter wavelength side.

On the other hand, when determining that the output DC voltage of the subtraction circuit 75 is greater than the voltage of the lock wavelength (YES in step S21), the process goes to step S23. In step S23, the drive current from the TEC driver (TEC-DRV) 79 is discretely changed so that the output light of the laser diode (LD) 41 is shifted towards the longer wavelength side.

After execution of step S22 or step S23, the process goes to step S24. In step S24, it is further determined whether the result of the comparison executed by the phase comparison section 83 is anti-phase. When determining that the result is in-phase (NO in step S24), the process goes back to step S21. On the other hand, when determining that the result is in-phase (YES in step S24), the process goes to step S25 to start the automatic frequency control (AFC).

### Flowchart of Process of Detecting Wavelength Displacement Amount

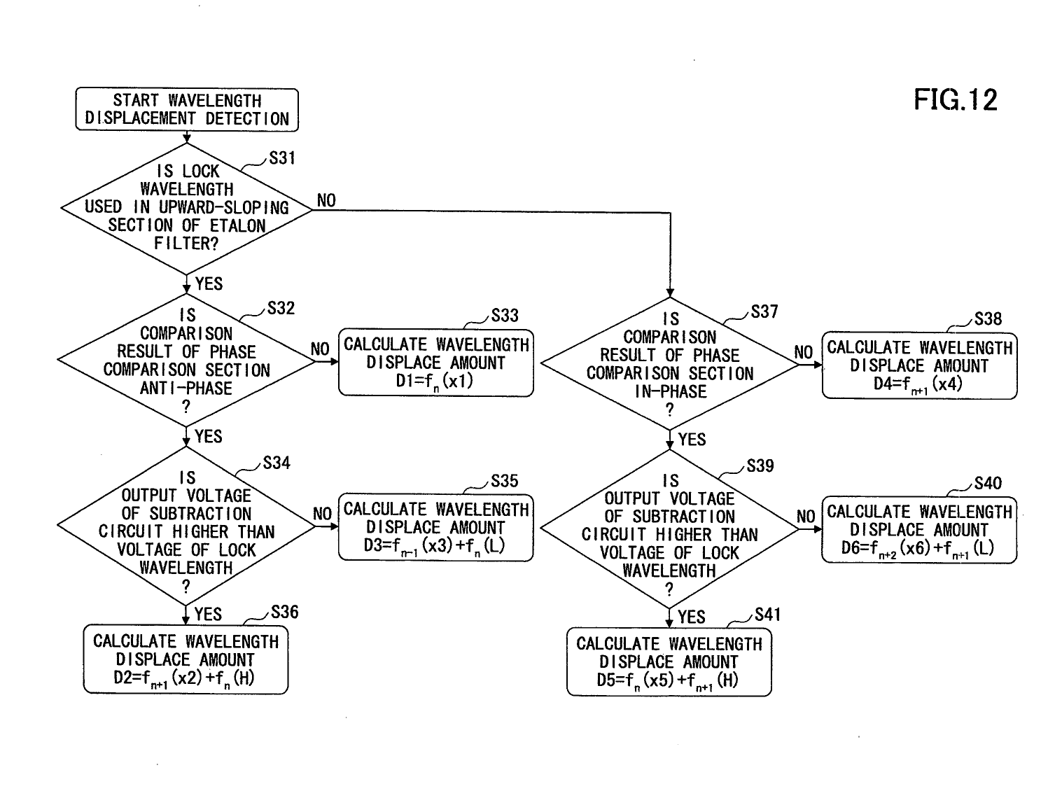

FIG. 12 is a flowchart illustrating a process of detecting the wavelength displacement amount performed by the automatic frequency control (AFC) and alarm detection section 78 according to an embodiment of the present invention. The process may be performed by the interruption at a predetermined period. As illustrated in FIG. 12, in step S31, it is determined whether the lock wavelength (wavelength lock point) is used in (disposed within) an upward-sloping section of the etalon filter (EF) 48.

When determining that the lock wavelength (wavelength lock point) is used in (disposed within) the upward-sloping section (YES in step S31), the process goes to step S32. In step S32, it is further determined whether the result of the comparison executed by the phase comparison section 83 is anti-phase (inverted phase). When determining that the result is in-phase (NO in step S32), the process goes to step S33 to calculate the wavelength displacement amount D1=fₙ(x1).

On the other hand, when determining that the result is anti-phase (YES in step S32), the process goes to step S34. In step S34, it is further determined whether the output DC voltage of the subtraction circuit 75 is greater than the voltage of the lock wavelength. When determining that the output DC voltage of the subtraction circuit 75 is equal to or less than the voltage of the lock wavelength (NO in step S34), the process goes to step S35 to calculate the wavelength displacement amount D3=fₙ₋₁(x3)+fₙ(L).

On the other hand, when determining that the output DC voltage of the subtraction circuit 75 is greater than the voltage of the lock wavelength (YES in step S34), the process goes to step S36 to calculate the wavelength displacement amount D2=fₙ₊₁(x2)+fₙ(H).

On the other hand, when determining that the lock wavelength (wavelength lock point) is used in (disposed within) a downward-sloping section (NO in step S31), the process goes to step S37. In step S37, it is further determined whether the result of the comparison executed by the phase comparison section 83 is in-phase. When determining that the result is anti-phase (NO in step S37), the process goes to step S38 to calculate the wavelength displacement amount D4=fₙ₊₁(x4).

On the other hand, when determining that the result is in-phase (YES in step S37), the process goes to step S39. In step S39, it is further determined whether the output DC voltage of the subtraction circuit 75 is greater than the voltage of the lock wavelength. When determining that the output DC voltage of the subtraction circuit 75 is equal to or less than the voltage of the lock wavelength (NO in step S39), the process goes to step S40 to calculate the wavelength displacement amount D6=fₙ₊₂(x6)+fₙ₊₁(L).

On the other hand, when determining that the output DC voltage of the subtraction circuit 75 is greater than the voltage of the lock wavelength (YES in step S39), the process goes to step S41 to calculate the wavelength displacement amount D5=fₙ(x5)+fₙ₊₁(H).

### Flowchart of Alarm Process

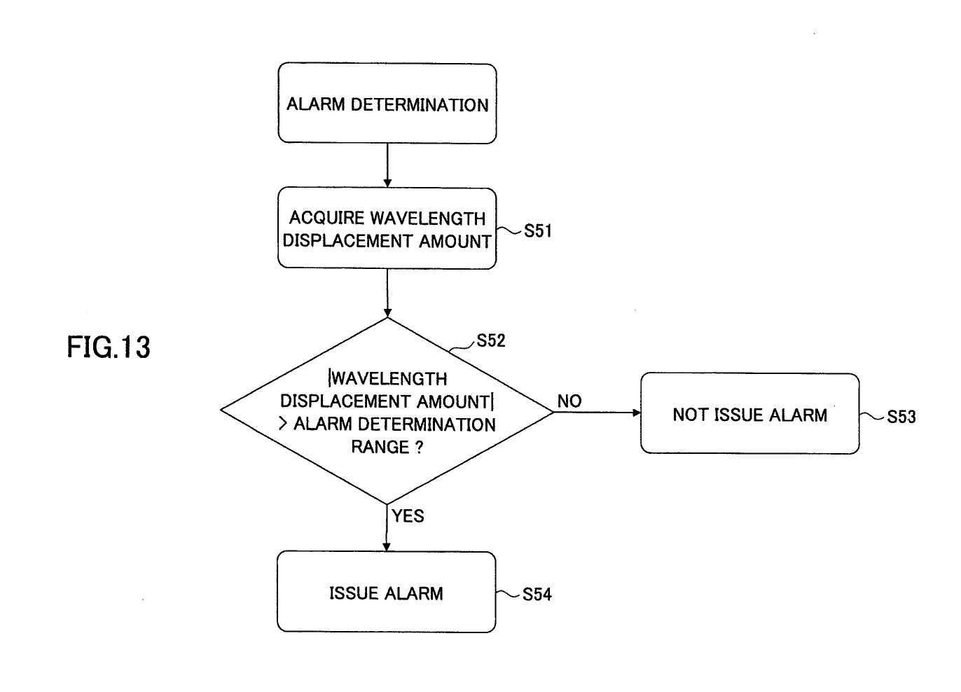

FIG. 13 is a flowchart illustrating an alarm process performed by the automatic frequency control (AFC) and alarm detection section 78 according to an embodiment of the present invention. The process may be performed by the interruption at a predetermined period.

As illustrated in FIG. 13, in step S51, the wavelength displacement amount (the value obtained in the procedure of FIG. 12) is acquired. Next, in step S52, it is determined whether the absolute value of the acquired wavelength displacement amount is greater than an alarm determination range. In this case, for example, the alarm determination range may be provided from an upper-level apparatus.

When determining that the absolute value of the acquired wavelength displacement amount is equal to or less than the alarm determination range (NO in step S52), the process goes to step S53, where no alarm is output (issued). On the other hand, when determining that the absolute value of the acquired wavelength displacement amount is greater than the alarm determination range (YES in step S52), the process goes to step S54 to output (issue) an alarm via the terminal 86.

### Flowchart of Monitor Output Process

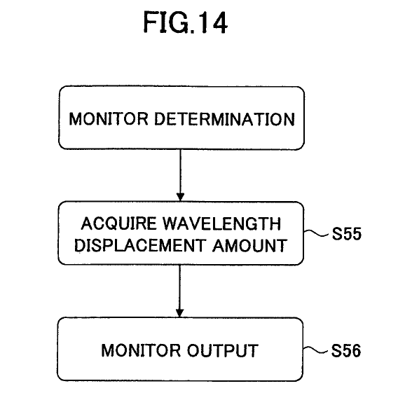

FIG. 14 is a flowchart illustrating a monitor output process performed by the automatic frequency control (AFC) and alarm detection section 78 according to an embodiment of the present invention. The process may be performed by the interruption at a predetermined period when the monitor output is set in advance from the upper-level apparatus or the like.

As illustrated in FIG. 14, in step S55, the wavelength displacement amount (the value obtained in the procedure of FIG. 12) is acquired. Next, in step S56, the acquired wavelength displacement amount is output via the terminal 85.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that various changes, substitutions, and alterations could be made hereto without departing from the sprit and scope of the invention.

What is claimed is:

1. An optical transmission module comprising:
a variable wavelength light source;
an alternating current adding unit to add an alternating current to a drive current to the variable wavelength light source;
a first detector to detect optical power of an output light from the variable wavelength light source;
a filter to input the output light from the variable wavelength light source in which transmission wavelength periodically increases and decreases and;
a second detector to detect optical power of transmitted light transmitted through the filter;
an extraction unit to extract a wavelength fluctuation component of the output light from the variable wavelength light source based on the optical power of the output light detected by the first detector and the optical power of the transmitted light detected by the second detector;
a phase comparison unit to compare a phase of the wavelength fluctuation component extracted by the extraction unit with a phase of the alternating current added to the drive current by the alternating current adding unit; and
a wavelength controller to control a wavelength of the output light from the variable wavelength light source to be a predetermined wavelength by controlling a temperature of the variable wavelength light source in response to the wavelength fluctuation component extracted by the extraction unit and a comparison result of the phase comparison unit.

2. The optical transmission module according to claim 1, wherein
the wavelength controller discretely controls the temperature of the variable wavelength light source when the predetermined wavelength is disposed at a position where a light transmission rate of the filter increases as the wavelength increases and the comparison result of the phase comparison unit indicates anti-phase.

3. The optical transmission module according to claim 1, wherein
the wavelength controller discretely controls the temperature of the variable wavelength light source when the predetermined wavelength is disposed at a position where a light transmission rate of the filter decreases as the wavelength increases and the comparison result of the phase comparison unit indicates in-phase.

4. The optical transmission module according to claim 1, wherein
the wavelength controller detects a wavelength displacement amount of the output light from the variable wavelength light source based on the wavelength fluctuation component extracted by the extraction unit and the comparison result of the phase comparison unit.

5. The optical transmission module according to claim 4, wherein
the wavelength controller outputs an alarm when the wavelength displacement amount of the output light from the variable wavelength light source exceeds a predetermined determination range.

6. A method of controlling a wavelength of an optical transmission module, the method comprising:
adding an alternating current to a drive current to a variable wavelength light source;
detecting optical power of output light from the variable wavelength light source;
detecting optical power of transmitted light transmitted through a filter that has characteristics in which transmission wavelength periodically increases and decreases and that inputs the output light from the variable wavelength light source;
extracting a wavelength fluctuation component of the output light from the variable wavelength light source based on the optical power of the output light and the optical power of the transmitted light;
comparing a phase of the extracted wavelength fluctuation component with a phase of the alternating current added to the drive current; and
controlling a wavelength of the output light from the variable wavelength light source to be a predetermined wavelength by controlling a temperature of the variable wavelength light source in response to the extracted wavelength fluctuation component and a comparison result of the phases.

7. The optical transmission module according to claim 6, wherein
in the controlling, the temperature of the variable wavelength light source is discretely controlled when the predetermined wavelength is disposed at a position where a light transmission rate of the filter increases as the wavelength increases and the comparison result indicates anti-phase.

8. The optical transmission module according to claim 6, wherein
in the controlling, the temperature of the variable wavelength light source is discretely controlled when the predetermined wavelength is disposed at a position where a light transmission rate of the filter decreases as the wavelength increases and the comparison result unit indicates in-phase.
